(19) United States
(12) Patent Application Publication
(10) Pub. No.: US 2012/0216384 A1
(43) Pub. Date: Aug. 30, 2012

(54) MANUFACTURING FACILITY WITH ROBOTIC CARRIER AND METHOD OF MANUFACTURING

(75) Inventor: William J. Immekus, Bloomfield Hills, MI (US)

(73) Assignee: Durr Ecoclean, Inc., Auburn Hills, MI (US)

(21) Appl. No.: 13/035,212

(22) Filed: Feb. 25, 2011

(51) Int. Cl. B23P 11/00; B23P 19/00

(52) U.S. Cl. 29/428; 29/791

(57) ABSTRACT

A workpiece manufacturing facility includes a plurality of workstations capable of performing work on a workpiece to dimensionally advance a configuration of the workpiece. A plurality of assembly stations is capable of assembling components of the workpiece to the workpiece. A carrier is moveable between any of the work stations and between any of the assembly stations. The carrier transports at least one workpiece between at least one work station and at least one assembly station. The carrier includes a robotic manipulator capable of introducing the workpiece to the workstations and the assembly stations in a dimensionally accurate position and the robotic manipulator is capable of performing work on the workpiece.

### BACKGROUND OF THE INVENTION

The present invention relates generally toward a new facility and method of manufacturing a workpiece. More specifically, the present invention relates to a manufacturing facility and method of manufacturing a workpiece making use of a carrier that includes a robotic manipulator and is movable between various work and assembly stations.

Since the advent of mass production, moving assembly lines have been used to transfer a workpiece through a manufacturing facility stopping or delivering the workpiece at different work or assembly stations. In some instances, the moving assembly line stops for a short period of time allowing work to be performed on the workpiece, after which a workpiece is moved to the next work or assembly station.

The introduction of robotic manipulators to mass production facilities increased the pace by which a moving assembly line could transfer a workpiece between work stations. However, the robotic manipulator typically performed a single task at a particular work station and was immovable. This type of manufacturing facility has not proved very flexible because the robotic manipulator has typically been only able to perform a single task at a given work station.

Occasionally, robotic manipulators have been made mobile by attaching the manipulator to a rail whereby the manipulator moves between work stations that are within range of the rail. However, these configurations have not proven to provide necessary manufacturing flexibility to account for the more diverse requirements of workpieces, particularly those used in automotive manufacturing. For example, to add an additional and different workpiece to a manufacturing facility, the moving assembly line necessarily requires a reconfiguration of the conveyor transporting the workpieces. Alternatively, the rail that moves the robotic manipulator between proximate work stations must be reconfigured or replaced. These revisions to the manufacturing facility are known to cause a loss of production while the facility is being reworked and, unnecessarily, to cause an increase in maintenance costs associated with the reconfiguration of the manufacturing facility.

Therefore, there is a strong felt need to provide a new type of manufacturing facility where additional levels of manufacturing complexity, based upon multiple types of workpiece design, can be achieved without a loss of manufacturing time and without costs associated with reworking the manufacturing facility.

### SUMMARY OF THE INVENTION

A workpiece manufacturing facility includes a plurality of work stations capable of performing work on a workpiece to dimensionally advance the configuration of the workpiece. Some manufacturing facilities also include a plurality of assembly stations where assembly components of the workpiece are assembled to the workpiece to further advance the dimensional configuration of the workpiece. A carrier is movable between any of the work stations and between any of the assembly stations. The carrier transports at least one workpiece between at least one workstation and at least one assembly station. The carrier includes a robotic manipulator capable of introducing the workpiece to the work stations and to the assembly station in a dimensionally accurate position. The robotic manipulator is capable of performing work on the workpiece once the workpiece is loaded into either the work station or the assembly station.

The novel manufacturing facility of the present invention eliminates that part of a manufacturing facility known to create bottlenecks in the manufacturing process, cost significant amounts of money to install and maintain, and prevent the manufacturing flexibility required of modern manufacturing facilities. The carrier of the present invention provides advancements over prior art automatic guided vehicles that have had limited capacity and have only been able to deliver raw material to predetermined destinations. The carrier of the present invention provides a capability of moving between any of a number of work stations or assembly station arranged in a manufacturing facility to facilitate the manufacturing of a workpiece as desired. Furthermore, the carrier of the present invention includes a robotic manipulator that is adapted to both introduce the workpiece to a work station or assembly station in a dimensionally accurate location, and can also perform work on the workpiece to advance the manufacture of the workpiece. This provides the ability of the carrier to transport and manufacture multiple variations of a workpiece, or even introduce new variations of an existing workpiece to a manufacturing facility without the cost of introducing expensive equipment to a manufacturing facility. For example, the introduction of a new variation of a workpiece now only requires the introduction of a new work station, or tooling to an existing work station without making any manufacturing alterations to an existing facility.

An additional benefit to the manufacturing facility is the ability to increase or otherwise alter production volumes without making any structural changes to the manufacturing facility. Should production volumes exceed existing capacity, an additional work station or assembly station is easily added and the carrier is reprogrammed to access the additional stations.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 shows a manufacturing facility of the present invention;

FIG. 2a shows a carrier of the present invention having a robotic manipulator in a retracted state;

FIG. 2b shows an expanded view of the carrier of the present invention;

FIG. 3 shows the carrier mated with a work station for performing work upon a workpiece;

FIG. 4 shows the carrier of the present invention mated to a washing/deburring station; and

FIG. 5 shows the carrier positioned adjacent and the assembly station for assembling a workpiece.

### DETAILED DESCRIPTION OF THE INVENTION

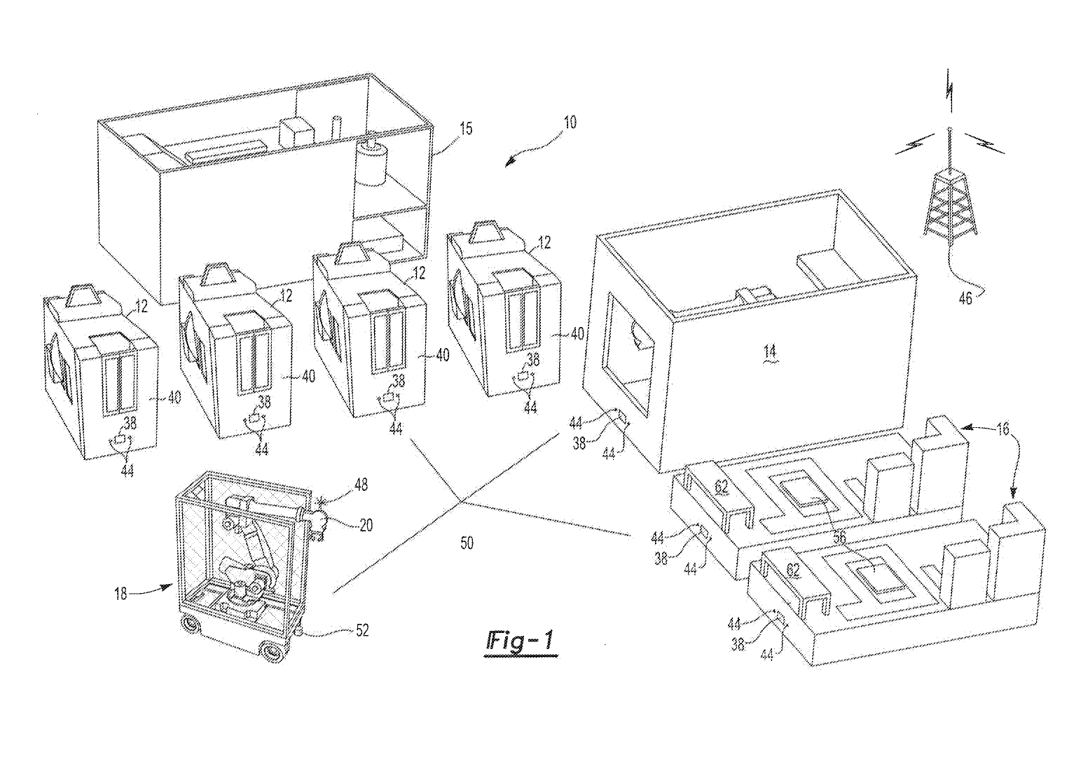

Referring to FIG. 1, the workpiece manufacturing facility of the present invention is generally shown at 10. The facility 10 includes a work station 12, or as contemplated by the inventor, a plurality of work stations 12 for performing work on a workpiece W. For example, the work station 12 includes tooling (not shown) used to machine and provide a dimensionally accurate configuration to the workpiece in a known manner. The workpiece is contemplated to be any product including, head cylinders, engine blocks, oil pump housings, or equivalent components manufactured by way of casting or other metal forming.

It is contemplated that a given workpiece can be completely machined to a dimensionally accurate configuration in a single work station, or be machined in a plurality of work stations as shown in FIG. 1. Therefore, a workpiece W is either made dimensionally accurate in a single work station 12, or is moved between a plurality of work stations 12, each of which advance the dimensional accuracy of a given workpiece.

Subsequent to machining a workpiece W, the workpiece is typically moved to a washing and deburring station 14. Metal shaving and working dust is removed from the workpiece W rendering the workpiece W clean enough for assembly of additional component to the workpiece W. Subsequent to washing and deburring, the workpiece W is transported to an assembly station 16 where additional components such as, for example, plugs and washers or other fittings are assembled to the workpiece W prior to delivering the completely assembled workpiece W to its final destination. A filter station 15 is fluidly connected to the workstations 12 and the washing and deburring station(s) 14 to clean the fluid used to cool the tooling disposed in the workstations 12 and to filter the fluid used to wash the workpieces W in the washing and deburring station 14. If necessary several filters 15 may be included in the facility to provide necessary filtering capacity.

Unlike prior art manufacturing facilities, the subject manufacturing facility 10 provides flexibility for manufacturing multiple types of workpieces heretofore not contemplated. This is achieved by way of a carrier 18 that moves a robotic manipulator 20 between any number of work stations 12, washing and deburring stations 14, and assembly stations 16. The carrier 18 is free ranging and is unrestricted in its movement around the manufacturing facility but for a preprogrammed path of travel as will be explained further below. Prior to beginning the manufacturing process, the carrier 18 retrieves the workpieces W from staging area (not show) where workpieces W have been removed from delivery pallets by a staging robot (not shown) and staged.

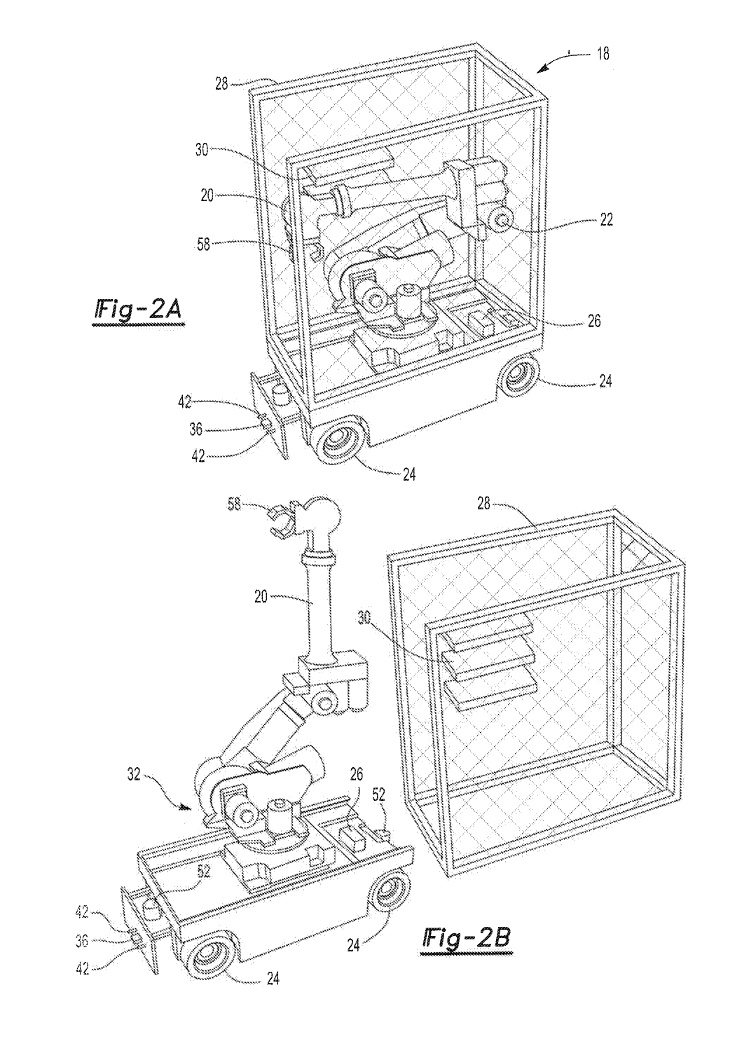

FIG. 2a shows the carrier 18 having the robotic manipulator 20 in a retracted position. The robotic manipulator 20 is locked into a retracted position by lock 22 when the carrier 18 is freely traversing the manufacturing facility 10. Furthermore, the robotic manipulator 20 is depowered when the carrier 18 is not docked to a work station 12 or the washing station 14 or the assembly station 16 to further prevent the robotic manipulator 20 from cycling while not from facilitating work upon the workpiece. The carrier freely moves around the facility 10 upon wheels 24 that are not structurally affixed to any components such as, for example, a rail or conveyor. The carrier is guided by a controller 26 mounted on the carrier. The controller 26, in addition to including directives for steering the carrier 18, includes operational controls for the robotic manipulator 20 when the carrier 18 is docked at one of the stations 12, 14, 16. The carrier 18 is powered by an 24 volt battery, which also serves as backup power source to the controller 26.

The carrier 18, as best seen in FIG. 2b, includes a cage 28 or other structural member that envelops the robotic manipulator 20. The cage 28 supports a buffer 30 used to transport a plurality of workpieces W to the various stations 12, 14, 16 of the manufacturing facility. Therefore, the robotic manipulator is capable of removing a workpiece from the buffer 30, inserting the workpiece in any of the stations 12, 14, 16, removing the workpiece from the stations 12, 14, 16 and returning the workpiece to the buffer 30. Further, the carrier is capable of transporting a plurality of workpieces to a given station 12, 14, 16 and performing work upon the plurality of workpieces prior to moving to a subsequent station 12, 14, 16 necessary to complete manufacturing of the workpiece. It should be understood by those of ordinary skill in the art that a manufacturing facility 10 may include only work stations 12 or assembly stations 14 and that the two stations are considered interchangeable as used herein.

Additional control (and locating) apparatus 32 is disposed on a leading end 34 of each carrier 18. The control apparatus includes a visioning device 34 capable of scanning a radius of 270° to identify obstacles or pedestrians located in the pathway of the carrier. The visioning device 34 takes the form of a scanner or an equivalent and signals the control apparatus 32 to temporarily stop the traverse of the carrier 18 along the manufacturing facility pending the removal of the obstacle identified by the vision device 34. The control apparatus 32 further includes a link 36 that takes the form of a multiple pin connector, such as an electrical interface that mates to a communication link 38 as shown on a forward face 40 of each station 12, 14, 16. The electrical interface, or link 36, receives electrical power via the communication link 38 to drive the robotic manipulator 20 to facilitate work on the workpiece. Furthermore, the link 36 is contemplated to receive control information via the communication link 38 to further control the robotic manipulator 20 to facilitate work upon the workpiece by providing instructions directly to the robotic manipulator or through the controller 26. It should be understood by those of ordinary skill in the art that the controller 26 located on the carrier 18 can also be programmed to independently direct the robotic manipulator 20 to facilitate work upon the workpiece even though the robotic manipulator 20 is powered via the communication link 38.

It is desirable to locate the carrier 18 relative to the stations 12, 14, 16 in a dimensionally accurate manner so that the workpiece is accurately located in each of the stations 12, 14, 16. The inventors contemplate several alternative locating methods, including physical datums, lasers, floor mounted wires, and indoor metrology systems. One or all of these options may be used as required. A carrier locator 42 interfaces with a station locator 44 disposed upon each of the stations 12, 14, 16 to dimensionally locate the carrier 18 relative to any of the stations 12, 14, 16. It should be understood that the robotic manipulator 20 is also dimensionally located upon the carrier 18 so that the carrier 18, when docked at a station 12, 14, 16 causes the robotic manipulator 20 to also be dimensionally located.

A first alternative guidance and locating method that may be used in combination with the carrier locator 42 or independently, is an indoor metrology system. The indoor metrology system makes use of a plurality of transmitting towers 46 spaced around the manufacturing facility that communicate with a metrology locator 48 disposed upon either the carrier 18 or the robotic manipulator 20. The metrology transmitters 46 triangulate with the metrology locator 48 to determine the location of the carrier 18 in the manufacturing facility 10 and provide input to the controller 26 to guide the carrier 18 around the facility 10 in a precise manner.

A second alternative locating and guidance system that may be used in combination with the other guidance locating systems is locating guide wire 50 in the floor of the facility 10. The wire 50 is detected by a sensor (not shown) on the carrier 18 that signals the controller 26 to follow the path laid out by the wire 50. A still further guidance and locating apparatus would make use of a laser 52 interfacing with a sensor 54 also located on the carrier 18. In this instance, the laser transmits a laser beam, in a 360° direction, which is reflected by reflectors (not shown), positioned in various known locations about the manufacturing facility 10. In this manner, the controller determines the location of the carrier 18 via triangulation. As set forth above, it is contemplated that any combination of the guidance and locating systems may be used to locate and guide the carrier to dimensionally desirable locations.

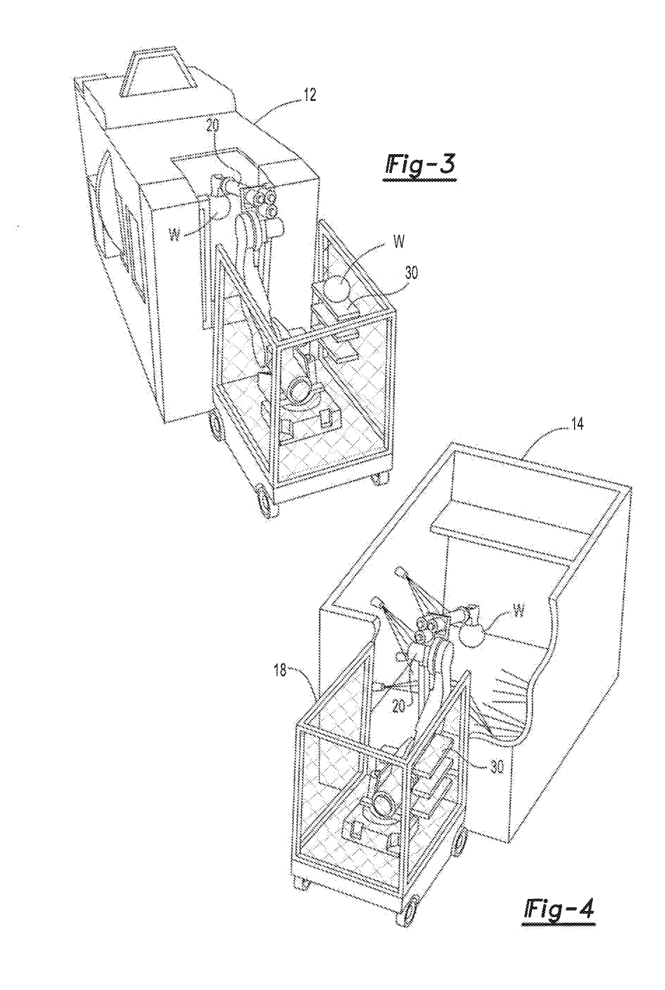

FIGS. 3-5 show the carrier 18 located proximate the work station 12, the washing station 14, and the assembly station 16, respectively. As shown in FIG. 3, the carrier 18 is placing the workpiece W, after it has been removed from buffer 30, into the work station 12 so that tooling disposed inside the work station 12 can perform work upon the workpiece to dimensionally advance the workpiece toward completion. As set forth above, the carrier 18 docks against the work station 12 and is dimensionally located via mating the carrier locator 42 to the station locator 44. Furthermore, the link 36 interfaces with the connector link 38 thereby providing electrical current necessary to operate the robotic manipulator 20 and remove the robotic manipulator from the locked position (as shown in FIG. 2A). It is also contemplated by the inventor that data necessary to operate the robotic manipulator 20 is transferred between the link 36 and the connector link 38. Alternatively, the controller 26 disposed upon the carrier 18 provides data necessary to operate the robotic manipulator 20.

It should also be understood by those of skill in the art that the robotic manipulator can either merely transfer the workpiece W into the work station 12 or perform work upon the workpiece W making use of tools (not shown) disposed inside the work station 12. Once the desired level of work is completed at the work station 12, the robotic manipulator 20 removes the workpiece W from the work station 12, places the workpiece upon the buffer 30, removes a new workpiece W from the buffer 30 and begins the work cycle again. Once each workpiece W has been processed through a particular work station 12, the robotic manipulator is locked via lock 22 and the carrier 18 separates itself from the work station 12 and either traverses to a second work station 12 for further processing, or traverses to the washing and deburring station 14 as shown in FIG. 4.

As is represented in FIG. 4, the carrier 18 is docked at the washing and deburring station 14. The docking procedure is substantially the same as that explained above when the carrier 18 docks to a work station 12. Once docked at the washing and deburring station 14, the robotic manipulator is directed to sequentially remove workpieces W from the buffer 30 and insert the workpieces W into the washing and deburring station 14 where each workpiece is cleaned for further assembly. It should be understood that the workpiece is either secured onto a fixture (not shown) inside the washing and deburring station 14 or is retained in the grasp of the robotic manipulator 20 during the cleaning cycle. Once each workpiece is cleaned, the carrier separates from the washing and deburring station 14 and traverses to the assembly station 16.

The assembly station is described more fully in co-pending U.S. patent application Ser. No. 12/840,093, which is incorporated herein by reference. Once the carrier 18 is docked at the assembly station 16, the robotic manipulator 20 secures the workpiece W to an assembly table 56. The workpiece W is dimensionally located on the assembly table 56 so that the robotic manipulator 20 can perform assembly functions upon the workpiece W. The robotic manipulator 20 includes a gripper 58 upon a distal end which is not only used to transfer the workpiece W to the various stations 12, 14, 16 but is designed to retrieve tools 60 from tool table 62 positioned adjacent the assembly table 56. Once the gripper 58 has secured a desired tool 60, the gripper begins performing assembly operation upon the workpiece W mounted on the assembly table 56. For example, a gripper can either perform the assembly operation necessary to complete the workpiece W by way of the tool 60 retrained by the gripper 58, or the robotic manipulator 20 can mount a tool 60 upon the assembly table 56 where it performs assembly operations upon the workpiece W as more fully described in co-pending U.S. patent application Ser. No. 12/840,093. Alternatively, should the robotic manipulator 20 not be able to keep pace with required cycle times, a stationary robot 64 can be provided to the assembly station 16 to perform assembly operations upon the workpiece W. The gripper 58 is also instructed by the controller 26 to retrieve assembly components to complete the workpiece, such as, for example, plugs, cylinders, bearings and washers and locate the components in a dimensionally accurate position to facilitate assembly of the workpiece W.

Upon completion of assembly of the workpiece W, the robotic manipulator 20 retrieves leak test fixtures 64 from the tool table 62 and secures the leak test fixtures 64 to the assembly table 56 to begin a test cycle to ensure the workpiece W has been assembled properly. Once each of the workpieces W disposed in the buffer 30 have been fully assembled, the robotic manipulator again is disposed in a locked position via the lock 22 and withdraws from the assembly station 16 to deliver the completed workpieces W to the desired location and retrieve new, unfinished workpieces W to begin the manufacturing cycle. It should be understood that multiple carriers 18 can traverse the manufacturing facility 10 simultaneously manufacturing workpieces W for increased production rate if necessary to support additional workpiece configurations or increased volumes. Additional stations need merely be added to the facility 10 without having to make adjustments to infrastructure such as, for example, conveyors for rails as known in the prior art manufacturing facilities. It is further contemplated by the inventor that the assembly stations 16 are designated to singular assembly operations. For example, one assembly station 16 is designated to assembly of the workpiece W and a second assembly station is designated to leak testing. It is also contemplated that the each assembly stations could perform partial assembly and partial leak testing upon a given workpiece W.

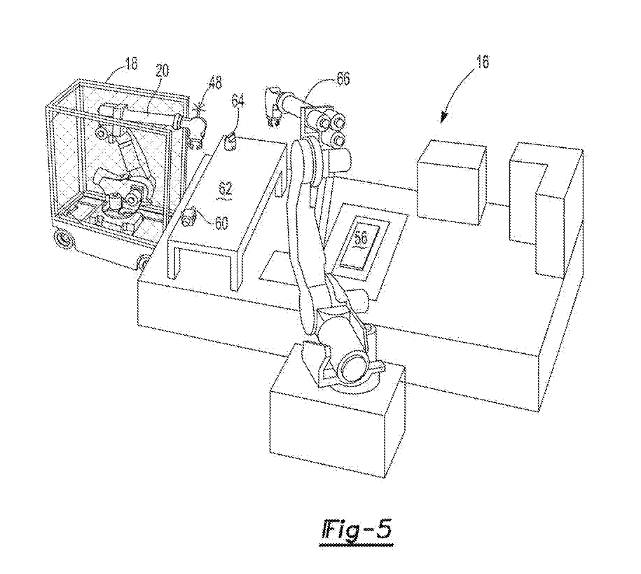

As more fully described in co-pending U.S. patent application Ser. No. 12/840,093, the robotic manipulator 20 is adapted to release the gripper 58 and pick up the tools on from the tool table 62, such as, for example, a torque head or ram to perform work on the workpiece W. The robotic manipulator 20 will perform assemble the workpiece W in the same manner as a stationary robotic manipulator 66 shown in FIG. 5. The stationary robotic manipulator 66 is included in the assembly station if production cycle times require additional assembly capacity.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, wherein reference numerals are merely for convenience and are not to be in any way limiting, the invention may be practiced otherwise than as specifically described.

What is claimed is:

1. A workpiece manufacturing facility, comprising:
a plurality of workstations capable of performing work on a workpiece thereby dimensionally advancing a configuration of the workpiece;
a plurality of assembly stations capable of assembling components of the workpiece to the workpiece; and
a carrier moveable between any of said work stations and between any of said assembly stations, said carrier transporting at least one workpiece between at least one work station and at least one assembly station and said carrier including a robotic manipulator capable of introducing the workpiece to said workstations and said assembly stations in a dimensionally accurate position and said robotic manipulator being capable of performing work on the workpiece.

2. The facility set forth in claim 1, wherein said carrier includes a workpiece buffer thereby transporting a plurality of workpieces to said workstations and said assembly stations.

3. The facility set forth in claim 1, wherein said robotic manipulator includes a receptor for obtaining and replacing tools used to perform work upon the workpiece.

4. The facility set forth in claim 1, wherein said carrier includes a controller programmed to direct said carrier to traverse said facility.

5. The facility set forth in claim 1, wherein said carrier includes a controller programmed to direct said robotic manipulator to perform work on said workpiece at any of said work stations and any of said assembly stations.

6. The facility set forth in claim 1, wherein said carrier includes a lock thereby rendering said robotic manipulator immovable relative to said carrier.

7. The facility set forth in claim 1, wherein said carrier includes a link for interfacing with said workstations and said assembly stations for establishing electrical connectivity to said robotic manipulator thereby enabling said robotic manipulator to perform work on said workpiece.

8. The facility set forth in claim 1, wherein said carrier includes a locator for locating the carrier relative to said work stations and said assembly stations.

9. The facility set forth in claim 8, wherein said locator comprises at least one of said metrology system, laser locator, guide wire or docking station interfacing with said work stations and said assembly stations.

10. The facility set forth in claim 1, wherein said carrier traverses between said workstations and said assembly stations unrestrained by structural apparatus.

11. A method of manufacturing a workpiece in a manufacturing facility having a plurality of production stations, comprising the steps of:
providing a mobile carrier unrestrained by physical attributes and including a robotic manipulator, said carrier having random access to each of said production stations;
digitally directing said carrier to traverse said manufacturing facility and access at least one of said production stations thereby providing access for said robotic manipulator to said production station;
digitally directing said robotic manipulator to transfer a workpiece to said production station and to facilitate work upon the workpiece at said production station thereby dimensionally advancing the workpiece; and
digitally directing said robotic manipulator to remove the workpiece from the production station and to transfer the workpiece to another production station for further processing of the workpiece.

12. The method set forth in claim 11, wherein said step of digitally directing said carrier to traverse said manufacturing facility is further defined by digitally directing said carrier by any combination of indoor metrology, floor mounted wire guidance, laser triangulation, guide wire and dimensionally docking said carrier at said production station.

13. The method set forth in claim 11, wherein said step of accessing at least one of said production stations is further defined by accessing a plurality of production stations.

14. The method set forth in claim 11, further including the step of said carrier transferring the workpiece between production stations while traversing said manufacturing facility.

15. The method set forth in claim 14, wherein said step of said carrier transferring the workpiece between production stations is further defined by transferring a plurality of workpieces between production stations.

16. The method set forth in claim 11, wherein said step of said robotic manipulator facilitating work upon the workpiece is further defined by said robotic manipulator using a tool to perform work upon the workpiece at said production station.

17. The method set forth in claim 11, wherein said step of accessing at least one production station is further defined by accessing a workstation, an assembly station, a cleaning station, or a transfer station.

18. The method set forth in claim 11, further including the step of disabling said robotic manipulator while said carrier is traversing said manufacturing facility.

19. The method set forth in claim 11, further including the step of providing said robotic manipulator with a gripper for gripping workpieces and tools used to perform work upon the workpiece.

20. The method set forth in claim 11, further including the step of providing electrical energy to said robotic manipulator when said carrier is docked at a production station.
